(19) United States
(12) Patent Application Publication
(10) Pub. No.: US 2025/0042771 A1
(43) Pub. Date: Feb. 6, 2025

(54) ELECTROLYTIC HYDROGEN-WATER CONTAINER

(71) Applicant: JOW TONG TECHNOLOGY CO., LTD., TAINAN CITY (TW)

(72) Inventor: CHUNG-HUNG LIN, TAINAN CITY (TW)

(21) Appl. No.: 18/362,167

(22) Filed: Jul. 31, 2023

(51) Int. Cl. C02F 1/00; C02F 1/461

(52) U.S. Cl. CPC C02F 1/003; C02F 1/46104; C02F 1/46109; C02F 2001/46152; C02F 2307/04

(57) ABSTRACT

An electrolytic hydrogen-water container is provided. The electrolytic hydrogen-water container includes a container and an electrolytic hydrogen-water module. The electrolytic hydrogen-water module generates hydrogen-rich water by electrolysis of water introduced. An assembly part and circular electrodes connected with a power source for conducting electricity are mounted in a bottom of the electrolytic hydrogen-water module while a bottom surface of the container is provided with a through hole for mounting the electrolytic hydrogen-water module. An assembly portion is disposed around the through hole for being connected with the assembly part of the electrolytic hydrogen-water module. Thereby the electrolytic hydrogen-water module can be mounted into the container with different styles and types and the electrolytic hydrogen-water container is more convenient to use.

### BACKGROUND OF THE INVENTION

### Field of the Invention

The present invention relates to an electrolytic hydrogen-water container, especially to an electrolytic hydrogen-water container in which an electrolytic hydrogen-water module is mounted into a container with different styles and types for electrolysis to generate hydrogen-rich water.

### Description of Related Art

Hydrogen water (also called hydrogen-rich water) is a water containing a lot of hydrogen ions. Hydrogen molecules are quite small and able to reach nerve system, cells, and organs directly for enhancing metabolism, adjustment of the body, and maintenance of health. They are natural antioxidants so that drinking hydrogen-rich water has multiple functions including anti-oxidation, anti-inflammation, anti-apoptosis, and cell repairing.

The amount of hydrogen gas dissolved in water is quite rare. The saturation concentration of H2 in water is 1.6 ppm which means 1.6 mg hydrogen dissolved in 1 kg water. According to previous papers and studies, the hydrogen-rich water becomes an antioxidant for removal of free radicals once its concentration reaches 0.3 ppm. However, the little amount of hydrogen gas dissolved in water is easy to dissipate once exposed in air. After experiments, data obtained shows that a half-life of the hydrogen water is about 2 hours in an open container. If users have hydrogen water machines in their homes, the half-life of the hydrogen water can be covered completely and the effects of the hydrogen water will not be reduced significantly.

Refer to Taiwanese Pat. Pub. No. M591799 “portable water cup with hydrogen water self-supplying function”, M547314 “water cup for producing hydrogen water”, and M603365 “water bottle with circuit connection function”, hydrogen water devices available on the market now are provided. However, these hydrogen water devices have fixed structure and the respective devices include corresponding containers such as cups or bottles. Once internal components or containers of the device are damaged, the hydrogen water device is unable to be used.

### SUMMARY OF THE INVENTION

Therefore, it is a primary object of the present invention to provide an electrolytic hydrogen-water container in which an electrolytic hydrogen-water module is mounted into a container with different styles and types for electrolysis to generate hydrogen-rich water.

In order to achieve the above object, an electrolytic hydrogen-water container according to the present invention includes a container and an electrolytic hydrogen-water module. The electrolytic hydrogen-water module generates hydrogen-rich water by electrolysis of water introduced. An assembly part and circular electrodes connected with a power source for conducting electricity are mounted in a bottom of the module while a bottom surface of the container is provided with a through hole for mounting the electrolytic hydrogen-water module. An assembly portion is disposed around the through hole for being connected with the assembly part of the electrolytic hydrogen-water module. Thereby the electrolytic hydrogen-water module can be mounted into the container with different styles and types and the electrolytic hydrogen-water container is more convenient to use.

Preferably, the assembly portion and the assembly part are provided with corresponding threads.

Preferably, one of the assembly portion and the assembly part is a L-shaped slot while the other is a protruding block. The protruding block is mounted into the L-shaped slot and rotated in a direction to be connected and positioned.

Preferably, the electrolytic hydrogen-water module further consists of a casing, a water pump, an electrolyzer, water channels, and a circuit board. The inlet is disposed on an upper end of the casing while the outlet is arranged at one side of the casing. The water pump is mounted in the casing and corresponding to the inlet for drawing water. Each of two ends of the electrolyzer is provided with one of the water channels. One end of the electrolyzer is connected with the water pump for introducing water into the electrolyzer while the other end is connected with the outlet. The electrolyzer is used for electrolysis and hydrogen dissolution. The circuit board is set on a bottom of the casing and electrically connected with the water pump, the electrolyzer, and the circular electrodes.

Preferably, a filter material is arranged at the inlet for filtering impurities in water. Then the filtered water is introduced into the electrolyzer of the electrolytic hydrogen-water module for electrolysis and hydrogen dissolution.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is a sectional view of an embodiment according to the present invention;

FIG. 2 is a partial enlarged view of a section of an embodiment according to the present invention;

FIG. 3 is a perspective view of an electrolytic hydrogen-water module viewed from bottom to top of an embodiment according to the present invention;

FIG. 4 is a schematic drawing showing connection of an electrolytic hydrogen-water module of an embodiment according to the present invention;

FIG. 5 is a sectional view showing an embodiment separated from a power supply base according to the present invention;

FIG. 6 is a sectional view showing an embodiment assembled with a power supply base according to the present invention.

### DETAILED DESCRIPTION OF THE PREFERRED EMBODIMENT

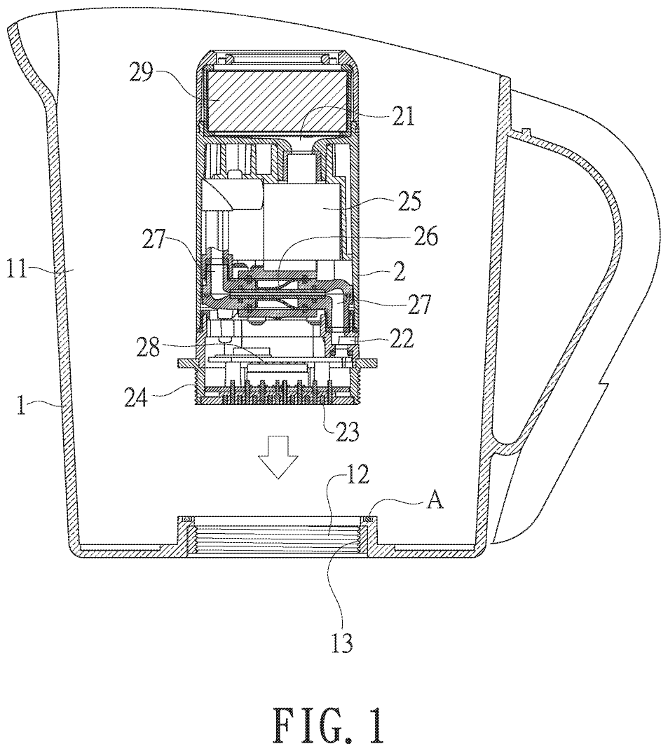

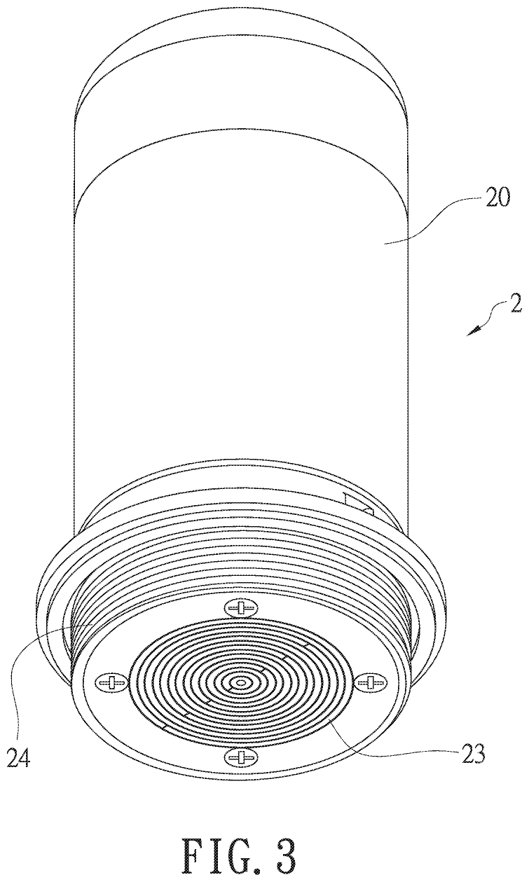

Refer to FIG. 1-3, an electrolytic hydrogen-water container according to the present invention mainly includes a container 1 and an electrolytic hydrogen-water module 2.

The container 1 consists of an inner space 11 for mounting water therein, a through hole 12 arranged at a bottom surface of the container 1, and an assembly portion 13 disposed around the through hole 12.

The electrolytic hydrogen-water module 2 is composed of an inlet 21, an outlet 22, a plurality of circular electrodes 23 disposed on a bottom of the electrolytic hydrogen-water module 2, and an assembly part 24 able to be aligned and connected with the assembly portion 13 of the container 1 correspondingly. The water is introduced into the electrolytic hydrogen-water module 2 through the inlet 21 for electrolysis and hydrogen dissolution and then hydrogen-rich water generated is output through the outlet 22. The electrolytic hydrogen-water module 2 is mounted in the through hole 12 of the container 1. The circular electrodes 23 is connected with a power source to conduct electricity for electrolysis.

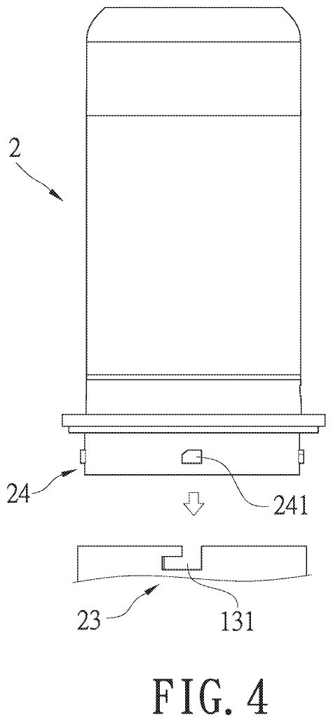

As shown in FIG. 1-5, while in use, the electrolytic hydrogen-water module 2 is mounted into the through hole 12 of the container 1 correspondingly by the assembly portion 13 of the through hole 12 connected with the assembly part 24 of the electrolytic hydrogen-water module 2. The way of connection can be threaded connection. That means the assembly portion 13 and the assembly part 24 are both provided with threads engaged with each other correspondingly. Or the assembly portion 13 and the assembly part 24 are rotated and locked with respect to each other. One of the assembly portion 13 and the assembly part 24 is a L-shaped slot 131 while the other is a protruding block 241. The protruding block 241 is first mounted into the L-shaped slot 131 and then rotated in a direction to be connected and positioned (as shown in FIG. 4). Besides the above two ways, other ways of connection can also be used. A seal ring A is disposed between the assembly part 24 of the electrolytic hydrogen-water module 2 and the assembly portion 13 of the through hole 12 of the container 1 to prevent the water in the inner space 11 from leaking. The above embodiments are used to show actual applications of the present invention, not intended to limit the scope of the present invention.

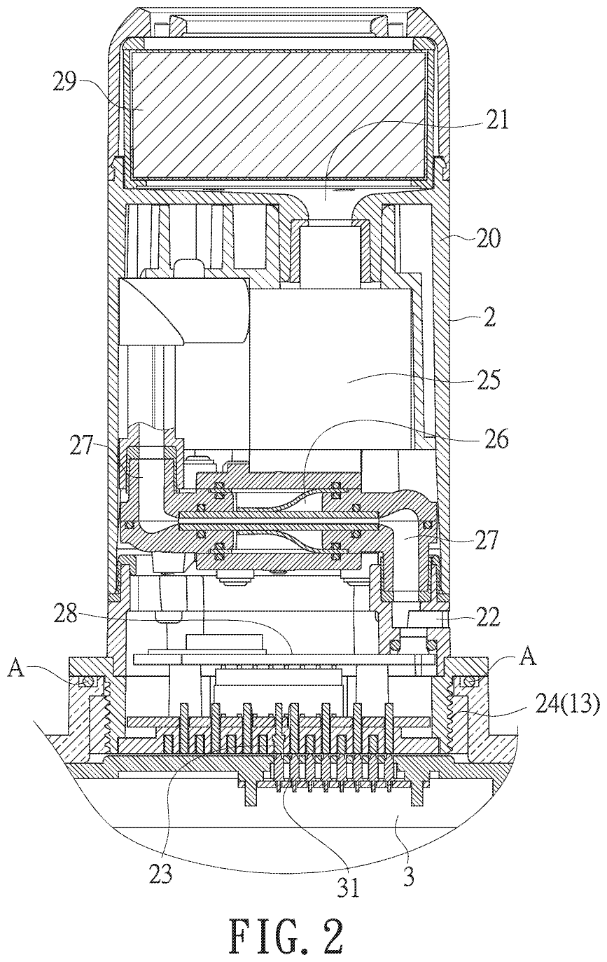

The container 1 can have different styles and types, able to be modified according to manufacturers' requirements or consumers' needs. After the electrolytic hydrogen-water module 2 being mounted in the container 1, water is filled into the inner space 11 of the container 1. Then the water is introduced into the electrolytic hydrogen-water module 2 through the inlet 21 for hydrolysis and hydrogen dissolution and then hydrogen-rich water obtained is output through the outlet 22. As shown in FIG. 2, the electrolytic hydrogen-water module 2 further consists of a casing 20, a water pump 25, an electrolyzer 26, at least two water channels 27, and a circuit board 28. The inlet 21 is arranged at an upper end of the casing 20 while the outlet 22 is disposed on one side of the casing 20. The water pump 25 is mounted in the casing 20 and corresponding to the inlet 21 for drawing water. Each of two ends of the electrolyzer 26 is provided with one of the water channels 27. One end of the electrolyzer 26 is connected with the water pump 25 for introducing water into the electrolyzer 26 while the other end thereof is connected with the outlet 22. The electrolyzer 26 is used for electrolysis and hydrogen dissolution. The circuit board 28 is disposed on a bottom of the casing 20 and electrically connected with the circular electrodes 23, the water pump 25, and the electrolyzer 26.

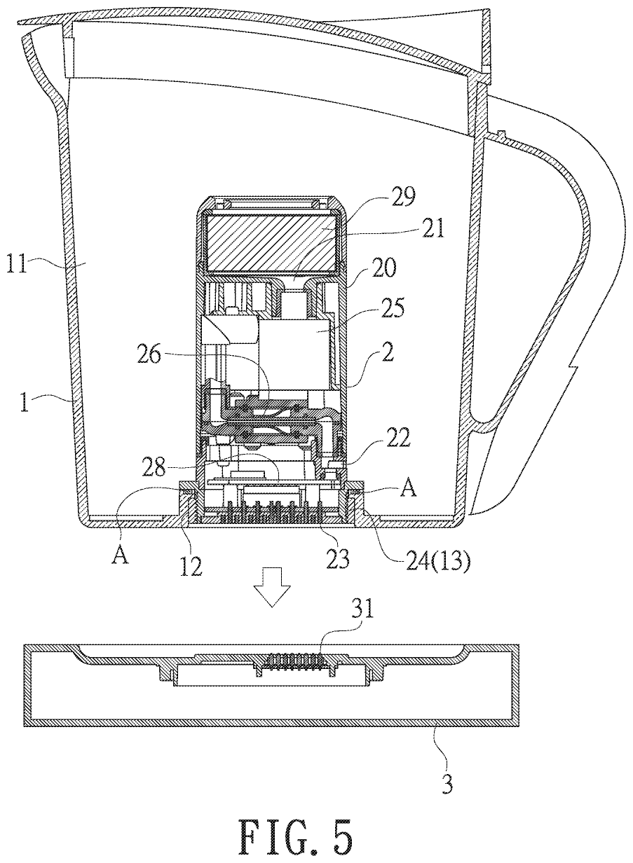

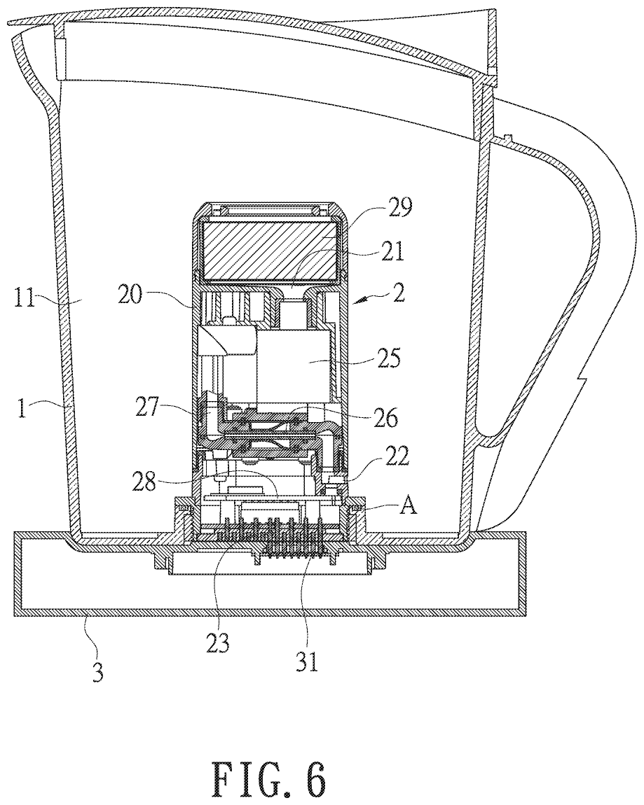

Refer to FIG. 5 and FIG. 6, the container 1 with the electrolytic hydrogen-water module 2 is placed over a power supply base 3. The power supply base 3 is provided with a plurality of electrode terminals 31 corresponding to the circular electrodes 23 of the electrolytic hydrogen-water module 2. By design of the circular electrodes 23, the electrode terminals 31 and the circular electrodes 23 contact each other in a conducting state no matter the container 1 is placed at which angle with respect to the power supply base 3.

After the water is filled into the inner space 11 of the container 1, the water pump 25 of the electrolytic hydrogen-water module 2 works to draw water. In order to make sure there are no impurities in the water, a filter material 29 is arranged at the inlet 21 for filtering impurities in the water. Then the water is delivered into the electrolyzer 26 for electrolysis and hydrogen dissolution. Next hydrogen water generated is output to the inner space 11 of the container 1 under guidance of the outlet 22. Thereby the water is treated by electrolysis and recycled in the container 1.

The electrolytic hydrogen-water container according to the present invention has the following advantages.
1. The detachable electrolytic hydrogen-water module can be mounted in the container with different styles and types and thus more convenient to use.
2. The electrolytic hydrogen-water module can be threaded with or rotated and locked with the container easily and conveniently. The module is easy to mount.
3. By arrangement of the circular electrodes, the electrode terminals and the circular electrodes can contact each other in a conducting state no matter the container is disposed on which angle with respect to the power supply base. Thereby the electrolytic hydrogen-water container is convenient to use.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalent.

What is claimed is:

1. An electrolytic hydrogen-water container comprising:
a container which includes an inner space for mounting water therein, a through hole arranged at a bottom surface of the container, and an assembly portion disposed around the through hole; and
an electrolytic hydrogen-water module mounted in the through hole of the container and having an inlet through which the water is introduced into the electrolytic hydrogen-water module for electrolysis and hydrogen dissolution to get hydrogen-rich water, an outlet through which the hydrogen-rich water is output, a plurality of circular electrodes disposed on a bottom of the electrolytic hydrogen-water module to conduct electricity for electrolysis, and an assembly part able to be aligned and connected with the assembly portion of the container correspondingly.

2. The device as claimed in claim 1, wherein the electrolytic hydrogen-water container further includes a power supply base which is electrically connected with the electrolytic hydrogen-water module and provided with a plurality of electrode terminals corresponding to the circular electrodes of the electrolytic hydrogen-water module.

3. The device as claimed in claim 1, wherein the electrolytic hydrogen-water module further includes a casing, a water pump, an electrolyzer, at least two water channels, and a circuit board; wherein the inlet is disposed on an upper end of the casing while the outlet is arranged at one side of the casing; the water pump is mounted in the casing and corresponding to the inlet for drawing water; each of two ends of the electrolyzer is provided with the one of the water channels; one end of the electrolyzer is connected with the water pump for introducing water into the electrolyzer while the other end thereof is connected with the outlet, the electrolyzer is used for electrolysis and hydrogen dissolution; the circuit board is mounted to a bottom of the casing and electrically connected with the water pump, the electrolyzer, and the circular electrodes.

4. The device as claimed in claim 1, wherein a filter material is arranged at the inlet for filtering impurities in the water and then the filtered water is introduced into the electrolyzer of the electrolytic hydrogen-water module for electrolysis and hydrogen dissolution.

5. The device as claimed in claim 1, wherein the assembly portion and the assembly part are provided with corresponding threads.

6. The device as claimed in claim 1, wherein one of the assembly portion and the assembly part is a L-shaped slot while the other of the assembly portion and the assembly part is a protruding block; the protruding block is mounted into the L-shaped slot and rotated in a direction to be connected and positioned.

7. The device as claimed in claim 1, wherein a seal ring is disposed between the assembly part of the electrolytic hydrogen-water module and the assembly portion around the through hole of the container to prevent the water in the inner space from leaking.

8. The device as claimed in claim 2, wherein the electrolytic hydrogen-water module further includes a casing, a water pump, an electrolyzer, at least two water channels, and a circuit board; wherein the inlet is disposed on an upper end of the casing while the outlet is arranged at one side of the casing; the water pump is mounted in the casing and corresponding to the inlet for drawing water; each of two ends of the electrolyzer is provided with the one of the water channels; one end of the electrolyzer is connected with the water pump for introducing water into the electrolyzer while the other end thereof is connected with the outlet, the electrolyzer is used for electrolysis and hydrogen dissolution; the circuit board is mounted to a bottom of the casing and electrically connected with the water pump, the electrolyzer, and the circular electrodes.

9. The device as claimed in claim 2, wherein a filter material is arranged at the inlet for filtering impurities in the water and then the filtered water is introduced into the electrolyzer of the electrolytic hydrogen-water module for electrolysis and hydrogen dissolution.

10. The device as claimed in claim 2, wherein the assembly portion and the assembly part are provided with corresponding threads.

11. The device as claimed in claim 2, wherein one of the assembly portion and the assembly part is a L-shaped slot while the other of the assembly portion and the assembly part is a protruding block; the protruding block is mounted into the L-shaped slot and rotated in a direction to be connected and positioned.

12. The device as claimed in claim 2, wherein a seal ring is disposed between the assembly part of the electrolytic hydrogen-water module and the assembly portion around the through hole of the container to prevent the water in the inner space from leaking.
